(19) United States
(12) Patent Application Publication
(10) Pub. No.: US 2016/0349605 A1
(43) Pub. Date: Dec. 1, 2016

(54) HOUSING, PHOSPHOR WHEEL DEVICE, AND PROJECTION APPARATUS

(71) Applicant: PANASONIC INTELLECTUAL PROPERTY MANAGEMENT CO., LTD., Osaka (JP)

(72) Inventor: Naoya KITADE, Osaka (JP)

(21) Appl. No.: 15/231,333

(22) Filed: Aug. 8, 2016

Related U.S. Application Data
(63) Continuation of application No. PCT/JP2015/004835, filed on Sep. 24, 2015.

(30) Foreign Application Priority Data
Mar. 19, 2015 (JP) 2015-056738

(51) Int. Cl. G03B 21/16; H04N 9/31; G02B 26/00

(52) U.S. Cl. CPC G03B 21/16; G02B 26/008; H04N 9/3144

(57) ABSTRACT

A housing stores a heat generator that rotates around a rotation axis. The housing includes a corrugated structure provided on a left wall and a right wall, which are parallel to the rotation axis, the corrugated structure being formed by distorting the left wall and the right wall.

### BACKGROUND

1. Technical Field

The present disclosure relates to a housing that stores a rotating heat generator; a phosphor wheel device configured to store a phosphor wheel serving as the rotating heat generator in the housing; and a projection apparatus including the phosphor wheel device.

2. Description of the Related Art

Unexamined Japanese Patent Publication No. 2003-156796 discloses a lighting optical system including a rotary optical filter device (phosphor wheel device). PTL 1 also describes that an opening is formed on the housing to radiate heat generated from an optical filter (phosphor wheel) in the housing and discloses the configuration for radiating heat generated in the housing to the outside with a fan through the opening.

### SUMMARY

A housing according to the present disclosure stores a heat generator that rotates around a rotation axis. The housing includes a corrugated structure, provided on a wall which is parallel to the rotation axis, the corrugated structure being formed by distorting the wall.

This configuration can provide a housing that can radiate heat generated from a rotating heat generator, while suppressing intrusion of dust in the housing and noise generation. The present disclosure also provides a phosphor wheel device configured to store a phosphor wheel serving as a rotating heat generator in the housing and a projection apparatus including a phosphor wheel device.

### BRIEF DESCRIPTION OF DRAWINGS

FIG. 1 is a block diagram illustrating the optical configuration of a projector apparatus according to a first exemplary embodiment;

FIG. 2 is a partially transparent perspective view illustrating the structure of a phosphor wheel device according to the first exemplary embodiment;

FIG. 3A is a partially transparent front view illustrating the phosphor wheel device according to the first exemplary embodiment;

FIG. 3B is a sectional view along line A-A in FIG. 3A;

FIG. 4 is a partially transparent front view illustrating a phosphor wheel device according to a second exemplary embodiment;

FIG. 5 is a partially transparent front view illustrating a phosphor wheel device according to another exemplary embodiment; and

FIG. 6 is a partially transparent front view illustrating a phosphor wheel device according to further another exemplary embodiment.

### DETAILED DESCRIPTION

Exemplary embodiments will be described below in detail with reference to the drawings as necessary. However, more than necessary detailed descriptions will sometimes be omitted. For example, detailed descriptions for matters which have already been well known in the art and redundant descriptions for substantially the same configurations will sometimes be omitted. This is to prevent the description below from becoming unnecessarily redundant to facilitate understanding of a person skilled in the art.

Note that the accompanying drawings and the following description are provided by the applicant in order for a person of ordinary skill in the art to sufficiently understand the present disclosure, and they are not intended to limit the subject matter set forth in the claims.

### FIRST EXEMPLARY EMBODIMENT

Projector apparatus 100 will be described as a specific exemplary embodiment of a housing, a phosphor wheel device, and a projection apparatus according to the present disclosure.

[1-1. Configuration]

[1-1-1. Configuration and Operation of Projector Apparatus]

The configuration and operation of projector apparatus 100 will be described.

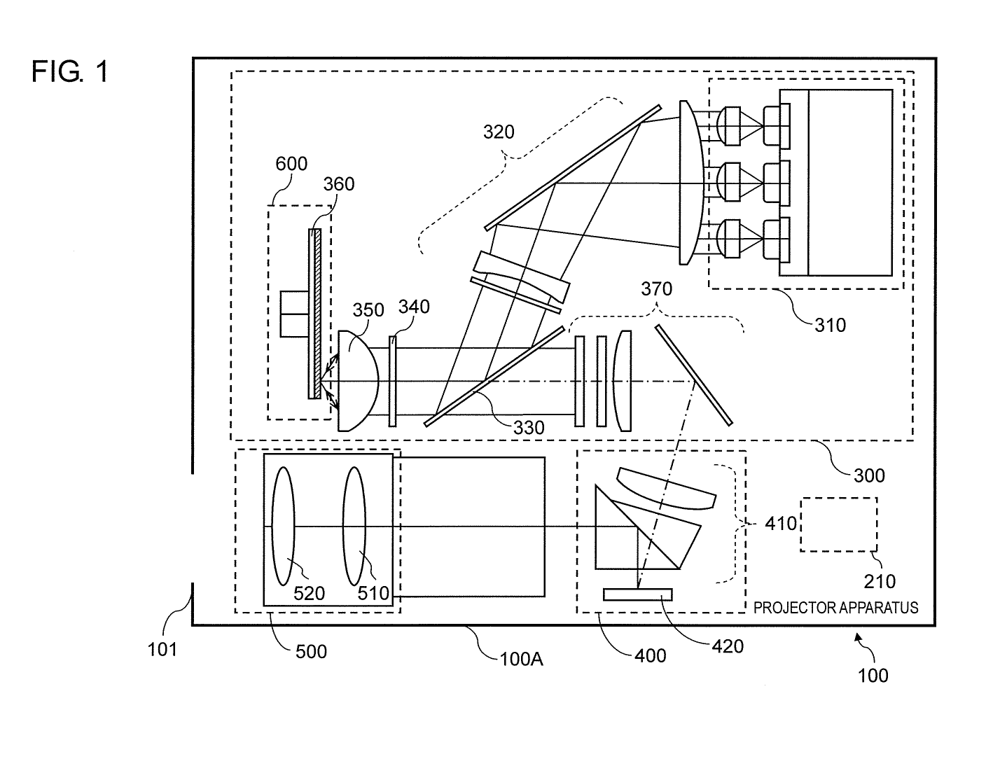

FIG. 1 is a block diagram illustrating the optical configuration of projector apparatus 100. As illustrated in FIG. 1, light source unit 300 supplies light, which is necessary for generating a projection image, to image generator 400. Image generator 400 supplies the generated video image to projection optical system 500. Projection optical system 500 performs optical conversion, such as focusing and zooming, to the video image supplied from image generator 400. Projection optical system 500 faces opening 101 formed on housing 100A of projector apparatus 100, and a video image is projected through opening 101. Further, the operation of each unit in projector apparatus 100 is controlled by controller 210.

Controller 210 includes, for example, a non-volatile memory in which a program is stored, a volatile memory that is a temporal memory area for executing a program, an input/output port, and a processor executing a program. Controller 210 supplies a video image signal that is to be projected to image generator 400. Controller 210 also controls the position of an optical member in projection optical system 500, for example. Note that controller 210 is indicated by a broken line in FIG. 1. This shows that the position where controller 210 is disposed is not limited, and may be set as appropriate.

The configuration of light source unit 300 will be described. As illustrated in FIG. 1, light source unit 300 includes semiconductor laser 310, dichroic mirror 330, λ/4 plate 340, phosphor wheel 360, and the like.

Semiconductor laser 310 is a solid light source that emits S-polarized blue light having a wavelength of 440 nm to 455 nm, for example. The S polarized blue light emitted from semiconductor laser 310 is incident on dichroic mirror 330 through light guide optical system 320.

For example, dichroic mirror 330 is an optical element having a high reflectance of 98% or more for the S polarized blue light having a wavelength of 440 nm to 455 nm and having a high transmittance of 95% or more for P polarized blue light having a wavelength of 440 nm to 455 nm and green light to red light having a wavelength of 490 nm to 700 nm regardless of a polarization state. Dichroic mirror 330 reflects the S polarized blue light emitted from semiconductor laser 310 toward λ/4 plate 340.

λ/4 plate 340 is a polarization element that converts linear polarized light into circular polarized light or converts circular polarized light into linear polarized light. λ/4 plate 340 is disposed between dichroic mirror 330 and phosphor wheel 360. The S polarized blue light incident on λ/4 plate 340 is converted into circular polarized blue light, and then, emitted to phosphor wheel 360 through lens 350.

Phosphor wheel 360 is an aluminum flat plate configured to be rotatable at a high speed. Phosphor wheel 360 has, on its surface, a plurality of B regions that is a region of a diffusion reflection plane, a plurality of G regions on which a phosphor emitting green light is applied, and a plurality of R regions on which a phosphor emitting red light is applied. Circular polarized blue light emitted to the B regions on phosphor wheel 360 is diffusely reflected, and again enters λ/4 plate 340 as circular polarized blue light. Circular polarized blue light incident on λ/4 plate 340 is converted into P polarized blue light, and then, again enters dichroic mirror 330. The blue light incident on dichroic mirror 330 at that time is P polarized light. Therefore, this blue light passes through dichroic mirror 330, and enters image generator 400 through light guide optical system 370.

Blue light emitted on the G regions on phosphor wheel 360 excites the phosphor applied on the G regions to allow the phosphor to emit green light. Green light emitted from the G regions enters dichroic mirror 330. The green light incident on dichroic mirror 330 at that time passes through dichroic mirror 330, and enters image generator 400 through light guide optical system 370. Similarly, blue light emitted on the R regions on phosphor wheel 360 excites the phosphor applied on the R regions to allow the phosphor to emit red light. The red light emitted from the R regions enters dichroic mirror 330. The red light incident on dichroic mirror 330 at that time passes through dichroic mirror 330, and enters image generator 400 through light guide optical system 370.

Due to the high-speed rotation of phosphor wheel 360, blue light, green light, and red light are time divided and emitted from light source unit 300 to image generator 400.

Image generator 400 generates a projection image according to a video image signal supplied from controller 210. Image generator 400 includes DMD (Digital-Mirror-Device) 420, and the like. DMD 420 is a display element on which a lot of micromirrors are arrayed on a flat plane. DMD 420 deflects each of the arrayed micromirrors according to the video image signal supplied from controller 210 to spatially modulate incident light. DMD 420 repeatedly receives blue light, green light, and red light which are time divided and emitted through light guide optical system 410. DMD 420 deflects each of the micromirrors in synchronization with the timing at which light of each color is emitted. With this, image generator 400 generates a projection image according to a video image signal. DMD 420 deflects the micromirrors to form light directed to projection optical system 500 and to form light directed outside an effective range of projection optical system 500, according to the video image signal. With this, image generator 400 can supply the generated projection image to projection optical system 500.

Projection optical system 500 includes optical members such as zoom lens 510 and focusing lens 520. Projection optical system 500 enlarges light directed from image generator 400 and projects the resultant light on a projection plane. Controller 210 adjusts the position of zoom lens 510, thereby being capable of controlling a projection region relative to a projection target in order to attain a desired zoom value. Controller 210 can enlarge a projection image onto a projection plane by increasing a zoom magnification. In this case, controller 210 moves zoom lens 510 in the direction in which an angle of view is increased (toward wide end) to expand the projection region. On the other hand, controller 210 can make a projection image to be projected onto a projection plane small by decreasing a zoom magnification. In this case, controller 210 moves zoom lens 510 in the direction in which an angle of view is decreased (toward tele end) to narrow the projection region. In addition, controller 210 adjusts the position of focusing lens 520 based on predetermined zoom tracking data so as to follow the movement of zoom lens 510, thereby being capable of performing focusing of a projection image.

[1-1-2. Configuration of Phosphor Wheel Device]

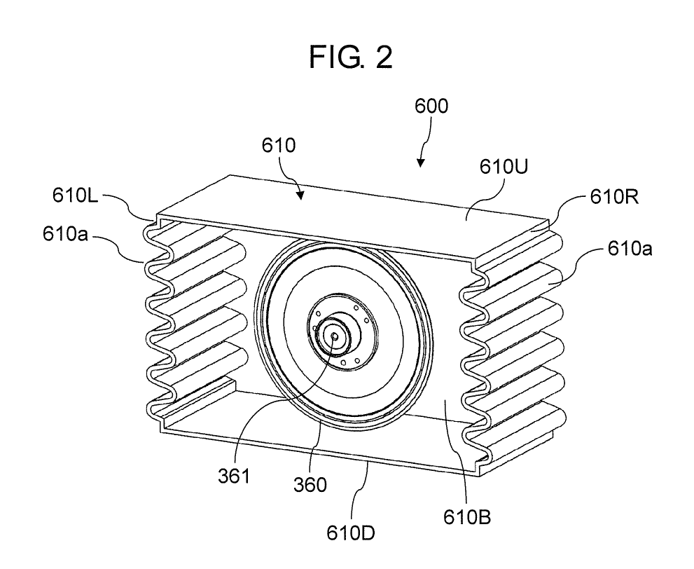

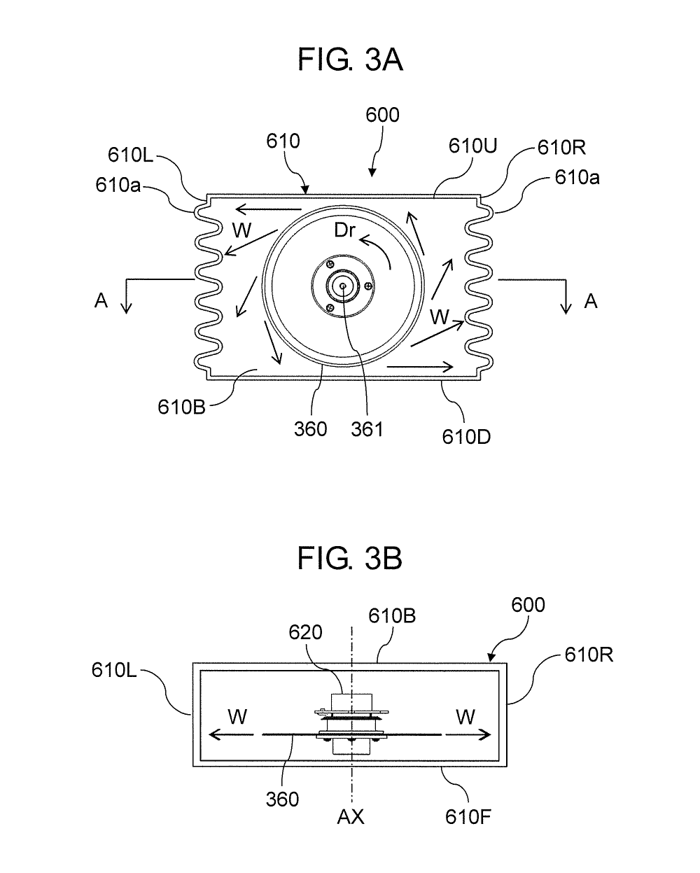

Phosphor wheel 360 is stored in the housing to be configured as a phosphor wheel device. The configuration of the phosphor wheel device will be described below. FIG. 2 is a partially transparent perspective view illustrating the structure of the phosphor wheel device according to a first exemplary embodiment. FIG. 3A is a partially transparent front view illustrating the phosphor wheel device according to the first exemplary embodiment. FIG. 3B is a sectional view along line A-A in FIG. 3A. Note that FIGS. 2 and 3A illustrate the phosphor wheel device with a front wall of the later-described housing being transparent.

Phosphor wheel device 600 includes phosphor wheel 360, motor 620 that rotates phosphor wheel 360, and housing 610 that stores phosphor wheel 360 and motor 620.

Housing 610 is a hexahedron having upper wall 610U, lower wall 610D, front wall 610F, back wall 610B, left wall 610L, and right wall 610R. Upper wall 610U and lower wall 610D face each other, front wall 610F and back wall 610B face each other, and left wall 610L and right wall 610R face each other. Notably, in the description in the present exemplary embodiment, the name of each wall is set according to “upper”, “lower”, “front”, “back”, “left”, and “right” in the drawings for the sake of convenience. However, “upper”, “lower”, “front”, “back”, “left”, and “right” here do not limit the orientation of phosphor wheel device 600 when it is used.

Housing 610 is closed while storing phosphor wheel 360. Gas is filled in an internal space of housing 610. Notably, a glass window (not illustrated) is formed on a part of front wall 610F, which is parallel to a main surface (front surface) of phosphor wheel 360, on housing 610 in order that blue light can be emitted to phosphor wheel 360 from the outside of housing 610.

Motor 620 is fixed to any one of the above-mentioned walls of housing 610 in housing 610. Rotation axis AX of motor 620 extends in the direction perpendicular to front wall 610F (back wall 610B). Phosphor wheel 360 is fixed to rotation shaft 361 of motor 620 such that the direction perpendicular to the main surface (front surface) of phosphor wheel 360 becomes parallel to rotation axis AX of motor 620. With this, phosphor wheel 360 is stored in housing 610 so as to be rotatable in rotation direction Dr around rotation axis AX perpendicular to front wall 610F (back wall 610B).

Corrugated structure 610a is provided on left wall 610L and right wall 610R, the corrugated structure being formed by regularly distorting left wall 610L and right wall 610R. Left wall 610L and right wall 610R are parallel to rotation axis AX. Corrugated structure 610a is a heat exchange unit for performing heat exchange for heat generated from rotating phosphor wheel 360 with gas outside of housing 610.

The corrugated shape of corrugated structure 610a is sinusoidal. More specifically, the corrugated shape of corrugated structure 610a when housing 610 is viewed from the direction (which is also a front-back direction in the present exemplary embodiment) parallel to rotation axis AX is sinusoidal. In other words, cross-sections of left wall 610L and right wall 610R of housing 610 which are parallel to the main surface (front surface) of phosphor wheel 360 have a sinusoidal shape.

Housing 610 is formed of aluminum. Note that housing 610 may be formed of metal other than aluminum, such as copper. It is to be noted that corrugated structure 610a may be formed from another component as a component constituting a part of left wall 610L and right wall 610R. In this case, only corrugated structure 610a may be formed of metal, and other portions of housing 610 may be formed of a material other than metal. Further, in a case where radiation performance by which the normal operation of phosphor wheel device 600 can be performed is obtained, corrugated structure 610a may also be formed of a material other than metal.

A fan that diffuses heat radiated to the outside from corrugated structure 610a may be provided on the outer side of housing 610 in the vicinity of left wall 610L and right wall 610R. Whether a fan is needed to be provided or not may be determined according to an amount of radiated heat.

[1-2. Operation]

The operation of phosphor wheel device 600 according to the present exemplary embodiment will be described with reference to FIGS. 3A and 3B. When phosphor wheel 360 rotates around rotation axis AX, swirl flow (wind) W around rotation axis AX is generated. Phosphor wheel 360 rotates at revolution of 10,000 per minute, for example. Thus, wind speed of swirl flow W becomes extremely high such as 20 m/sec. to 30 m/sec. The generated wind is mainly blown to upper wall 610U, lower wall 610D, left wall 610L, and right wall 610R of housing 610, these walls being parallel to rotation axis AX. In this case, in the present exemplary embodiment, corrugated structure 610a formed by distorting left wall 610L and right wall 610R is provided on each of left wall 610L and right wall 610R. Therefore, wind blown to left wall 610L and right wall 610R flows along the inner surface of corrugated structure 610a. In addition, since the area of the inner surface of left wall 610L and right wall 610R is increased more than a case where corrugated structure 610a is not provided, an area to which wind is blown in housing 610 is increased. Thus, heat exchange between the inside of housing 610 and external space of housing 610 is accelerated. Accordingly, in the present exemplary embodiment, housing 610 has a sealed structure without providing a fan in housing 610. This configuration enables satisfactory radiation of heat generated from phosphor wheel 360 to the outside, while suppressing intrusion of dust into housing 610 and noise generation.

In addition, in the present exemplary embodiment, since the corrugated shape of corrugated structure 610a is sinusoidal, swirl flow W smoothly flows along the inner surface of corrugated structure 610a. Therefore, swirl flow W flows while keeping a high wind speed. Accordingly, heat exchange between the inside of housing 610 and external space of housing 610 can more effectively be performed through corrugated structure 610a.

Hereinafter, a comparative example will be described. It is considered as a comparative example that a housing is formed into a hexahedron as in the exemplary embodiment with a left wall and a right wall, which are flat, and a heat sink having a cooling fan is provided to the outer surfaces of the left wall and the right wall. In this case, the area of the inner surfaces of the left wall and the right wall are not increased as in the present exemplary embodiment. That is, the area to which swirl flow (wind) W is blown is not increased in the cooling structure having the heat sink. Further, the volume of the internal space of the housing is not increased. Accordingly, in the comparative example, the heat exchange effect as in the present exemplary embodiment cannot be obtained.

[1-3. Effects]

Housing 610 according to the present exemplary embodiment is a housing which stores phosphor wheel 360 (heat generator) rotating around rotation axis AX.

Housing 610 includes corrugated structure 610a on left wall 610L and right wall 610R which are parallel to rotation axis AX, corrugated structure 610a being formed by distorting left wall 610L and right wall 610R.

This configuration enables satisfactory radiation of heat generated from phosphor wheel 360, which rotates around rotation axis AX, to the outside, while suppressing intrusion of dust into housing 610 and noise generation.

In the present exemplary embodiment, the corrugated shape of corrugated structure 610a is sinusoidal.

Thus, swirl flow W smoothly flows along the inner surface of corrugated structure 610a. Accordingly, heat exchange between the inside of housing 610 and external space of housing 610 can more effectively be performed through corrugated structure 610a.

In the present exemplary embodiment, the heat generator is phosphor wheel 360 that converts received light into light having another wavelength and outputs the resultant light.

With the configuration described above, temperature rise of phosphor wheel 360, which generates heat upon converting received light into light having another wavelength and outputting the resultant light, can be suppressed.

Phosphor wheel device 600 according to the present exemplary embodiment includes housing 610 and phosphor wheel 360.

Thus, the temperature rise of phosphor wheel device 600 can be suppressed.

Projector apparatus 100 (projection apparatus) according to the present exemplary embodiment outputs light output from a light source through phosphor wheel device 600.

With this, temperature rise of projector apparatus 100 can be suppressed.

### SECOND EXEMPLARY EMBODIMENT

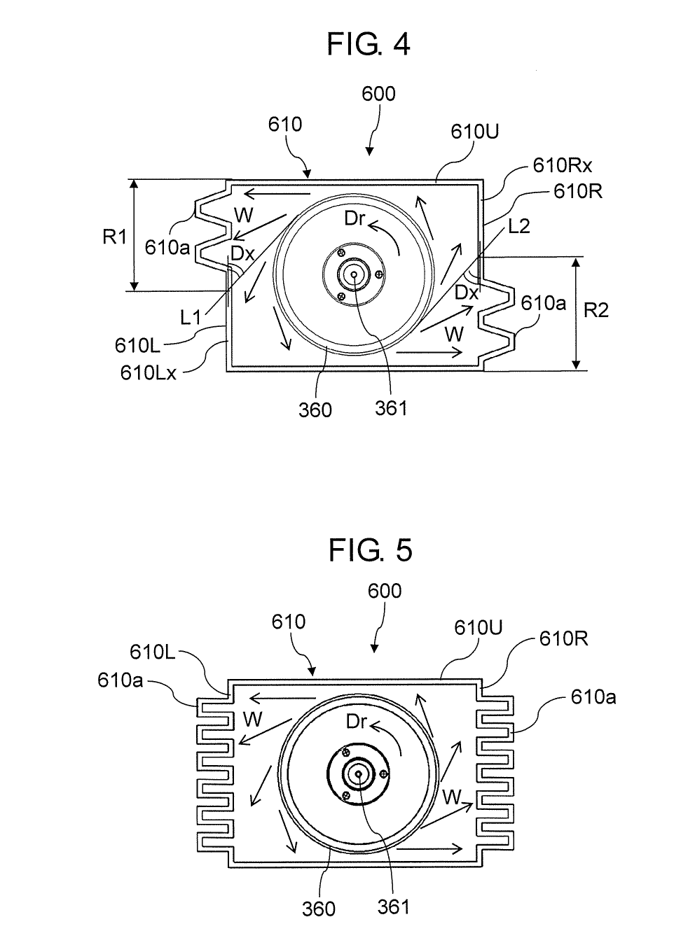

A second exemplary embodiment will be described. FIG. 4 is a partially transparent front view illustrating a phosphor wheel device according to the second exemplary embodiment.

In the present exemplary embodiment, corrugated structure 610a is provided on only a part of left wall 610L and right wall 610R. Specifically, corrugated structure 610a is provided on only an upper part of left wall 610L and a lower part of right wall 610R. More specifically, corrugated structure 610a on left wall 610L is provided in region R1 where the angle made by line L1, which is formed by extending a tangent line that touches the circumference of a rotating body to left wall 610L, and reference plane 610Lx of left wall 610L becomes equal to or larger than predetermined angle Dx. Further, corrugated structure 610a on right wall 610R is provided in region R2 where the angle made by line L2, which is formed by extending a tangent line that touches the circumference of a rotating body to right wall 610R, and reference plane 610Rx of right wall 610R becomes equal to or larger than predetermined angle Dx. The upper part of left wall 610L and the lower part of right wall 610R are the regions where swirl flow W generated due to the rotation of phosphor wheel 360 in direction of Dr is blown from the front or nearly from the front (at the angle equal to or larger than predetermined angle Dx), out of the upper part of left wall 610L and the lower part of right wall 610R.

With this configuration, projection portions projecting to the outside with the formation of corrugated structure 610a can be decreased. Thus, this configuration can decrease an arrangement space of the phosphor wheel device, while maintaining certain cooling performance.

### OTHER EXEMPLARY EMBODIMENTS

As described above, the first and second exemplary embodiments have been described above as an illustration of the technology disclosed in the present application. However, the technology in the present disclosure is not limited to these, and can be applied to exemplary embodiments in which various changes, replacements, additions, omissions, etc., are made. Furthermore, a new exemplary embodiment can be formed by combining each component described in the first and second exemplary embodiments.

The other exemplary embodiments will be described below.

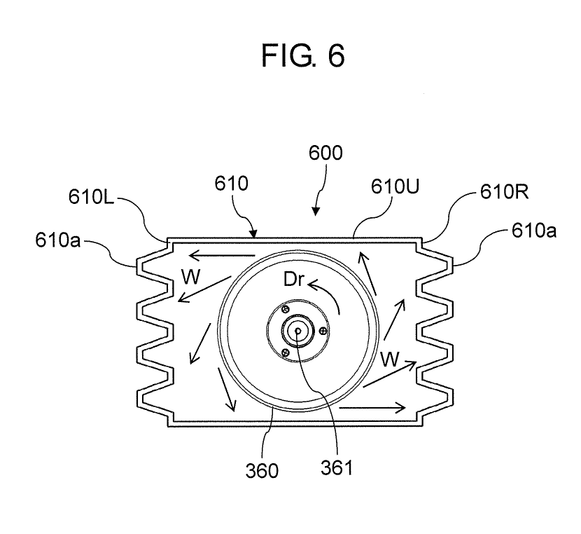

In each of the above exemplary embodiments, the corrugated shape of corrugated structure 610a is sinusoidal. However, in the present disclosure, the corrugated shape of corrugated structure 610a may be rectangular as illustrated in FIG. 5. Alternatively, in the present disclosure, the corrugated shape of corrugated structure 610a may be trapezoidal as illustrated in FIG. 6. In these cases, corrugated structure 610a may be provided on only an upper part of left wall 610L and a lower part of right wall 610R as in the second exemplary embodiment.

Further, in the present disclosure, the corrugated shape of corrugated structure 610a when housing 610 is viewed from the direction parallel to the vertical direction may be sinusoidal, rectangular, or trapezoidal.

Further, in the present disclosure, the corrugated shape of corrugated structure 610a may be other than sinusoidal shape, rectangular shape, or trapezoidal shape. Further, the corrugated shape of corrugated structure 610a may be a combination of a sinusoidal shape, a rectangular shape, a trapezoidal shape, or shapes other than these shapes.

In the above second exemplary embodiment, corrugated structure 610a is provided on only a part of left wall 610L and right wall 610R, specifically, on only an upper part of left wall 610L and a lower part of right wall 610R. However, in the present disclosure, the part may be a central part of left wall 610L and right wall 610R in the vertical direction. Also in this case, cooling effect with corrugated structure 610a is provided, since swirl flow W generated due to the rotation of phosphor wheel 360 in the direction of Dr is blown to corrugated structure 610a. In addition, the arrangement space of the phosphor wheel device can be reduced.

In each of the above exemplary embodiments, corrugated structure 610a is provided on only left wall 610L and right wall 610R. However, in the present disclosure, corrugated structure 610a may further be provided to upper wall 610U and lower wall 610D. With this configuration, cooling performance can further be enhanced.

In each of the above exemplary embodiments, housing 610 is a hexahedron having upper wall 610U, lower wall 610D, front wall 610F, back wall 610B, left wall 610L, and right wall 610R. However, in the present disclosure, the housing is not limited to a hexahedron, and may be a polyhedron having more than six surfaces. In this case as well, a corrugated structure formed by distorting a wall parallel to a rotation axis may be provided on the wall, as in each of the above exemplary embodiments.

In each of the above exemplary embodiments, a heat generator is phosphor wheel 360. However, in the present disclosure, a heat generator may be of any type, so long as it rotates around rotation axis AX.

As described above, the exemplary embodiments have been described above as an illustration of the technology in the present disclosure. The accompanying drawings and the detailed description are provided for this purpose.

Thus, elements described in the accompanying drawings and the detailed description include not only those that are essential, but also those that are not essential but are merely used to illustrate the technology disclosed herein. Therefore, those non-essential elements should not immediately be taken as being essential for the reason that they are described in the accompanying drawings and/or in the detailed description.

Further, the exemplary embodiments above are for illustrating the technology in the present disclosure, and various changes, replacements, additions, omissions, etc., can be made without departing from the scope defined by the claims and equivalents thereto.

The present disclosure is widely applicable to an apparatus including a heat generator that rotates, such as a phosphor wheel.

What is claimed is:

1. A housing that stores a heat generator rotating around a rotation axis, the housing comprising
a corrugated structure, provide on a wall parallel to the rotation axis, formed by distorting the wall,
wherein the corrugated structure is provided in a region of the wall where an angle made by a line, which is formed by extending a tangent line touching a circumference of the rotating body toward the wall, and a reference plane of the wall becomes equal to or larger than a predetermined angle.

2. The housing according to claim 1, wherein a corrugated shape of the corrugated structure is sinusoidal.

3. The housing according to claim 1, wherein a corrugated shape of the corrugated structure is rectangular.

4. The housing according to claim 1, wherein a corrugated shape of the corrugated structure is trapezoidal.

5. The housing according to claim 1, wherein the heat generator is a phosphor wheel that converts received light into light having another wavelength and outputs the resultant light.

6. A phosphor wheel device comprising: a housing and a phosphor wheel,
wherein the housing stores a heat generator that rotates around a rotation axis and includes a corrugated structure, provided on a wall parallel to the rotation axis, formed by distorting the wall, and
the heat generator is the phosphor wheel that converts received light into light having another wavelength and outputs the resultant light.

7. A projection apparatus that outputs, through a phosphor wheel device, light output from a light source,
wherein the phosphor wheel device includes a housing and a phosphor wheel,
the housing stores a heat generator that rotates around a rotation axis and includes a corrugated structure, provided on a wall parallel to the rotation axis, formed by distorting the wall, and
the heat generator is the phosphor wheel that converts received light into light having another wavelength and outputs the resultant light.
